(19) United States
(12) Patent Application Publication
(10) Pub. No.: US 2024/0299925 A1
(43) Pub. Date: Sep. 12, 2024

(54) Aspirator with pipetting function

(71) Applicant: ERGASTA APS, Ega (DK)

(72) Inventor: Dang Quang Svend Le, Ega (DK)

(21) Appl. No.: 18/547,631

(22) PCT Filed: Feb. 22, 2022
(86) PCT No.: PCT/EP2022/054415

§ 371 Date: Aug. 23, 2023

(30) Foreign Application Priority Data
Feb. 26, 2021 (DK) PA 2021 00206

(51) Int. Cl. B01L 3/02

(52) U.S. Cl. CPC B01L 3/0217; B01L 2400/049; B01L 2400/0655

(57) ABSTRACT

A vacuum aspirator is shown that includes an integrated pipetting function, which device may be used for handling liquids, especially to exchange or remove liquids or liquid residues in biosciences, biomedical sciences, chemistry, materials science. The air displacement pipette includes i) a suction conduit adapted for being fluidly connected to a suction unit; and ii) a valve adapted for controlling the fluid flow through the suction conduit.

### TECHNICAL FIELD OF THE INVENTION

The present invention relates to a vacuum aspirator comprising an integrated pipetting function, which device may be used for handling liquids, especially to exchange or remove liquids or liquid residues in biosciences, biomedical sciences, chemistry, and materials science. In particular, the present invention relates to an aspirator for use within the field of exchange or removal of supernatant and cell culture media in the maintenance of 3-dimensional cell cultures e.g., organoids, scaffold-assisted 3-dimensional cell culture.

### BACKGROUND OF THE INVENTION

Vacuum aspirators are laboratory liquid handling devices used in cell biology, biotech, pharma, medical engineering etc. adapted to remove fluid residues, e.g., from open containers, by aspiration. Normally, such an aspiration device comprises a suction line connected to a vacuum pump by a first end, and the device comprises a valve, which is operatively connected to the suction line for activation and deactivation of the suction function.

The valve is usually incorporated in a manual control part to enable easy operation of the valve by the user such as e.g., disclosed in U.S. Pat. No. 20,130,082204A1.

State of the art aspirators work very well when the sample is resilient to be removed with suction, i.e., being strongly adherent to the container, being cohesive, and/or being too big to pass through the aspirator suction tip. As such, aspirators have found a role in the maintenance of adherent cells on cell culture plastic.

However, for highly delicate aspiration from e.g., scaffold cell cultures, hydrogel cell cultures, e.g., Algimatrix (TM) (Thermo Fisher Scientific), weakly adherent cell cultures, e.g., embryonic stem cells, it is necessary to aspirate media/buffer using a manual pipette to 1) have maximum tactile control over aspiration volume and aspiration rate, 2) have the ability to reverse any inadvertent suction, and 3) be able to gauge the volume of aspirated liquid.

Such a scenario, however, requires the operator to include multiple additional motions into each repetitive aspiration, such as:
1) Depress plunger,
2) Aspirate to the pre-set volume,
3) Move hand and tip to liquid waste container,
4) Blow-out on plunger, and
5) Move hand and tip back to work area.

These steps put additional strain on the operator's hands, wrists, elbows, and shoulders, thereby increasing the risk of Cumulative Trauma Disorders. Furthermore, for sterile handling, the increased movement and sweeping arm motions and operating time in the flow hood increases the risk of contamination. Such a risk is present even with use of electronic pipettes.

Hence, an improved pipette would be advantageous, and in particular a pipette comprising an aspiration function, which needs not be moved back and forth between the work area and the waste container.

U.S. Pat. No. 20,130,82204 (A1) discloses a manual control part of a suction device with a valve. The valve connects to a pipette tip upstream and a manual control part downstream. The valve is opened by compressing an elastic jacket, thereby allowing suction at the pipette tip.

This invention relates to a vacuum aspiration tool, which can be opened/closed. The advantages of a manual pipette handle are not present e.g., it does not comprise a tip ejector button at the handle, it does not control of aspiration volume or allow for reversing suction.

U.S. Pat. No. 5,614,153 (A) discloses a tip ejector for a pipette for aspirating and dispensing measured quantities of liquids. However, this document does not comprise a connection to vacuum source, and therefore it comprises no valve.

U.S. Pat. No. 5,983,733 (A) discloses a manual pipette with an ergonomic tip ejector button. The device does not comprise a connection to a vacuum source, and therefore disclose no valve.

WO 2006038130 (A2) discloses a valve comprising a bending sleeve functioning as a valve by making a kink in a flexible tube, which kink closes off the flow in the flexible tube. However, this device does not work by exactly the same principle as the valve of the present invention, as the valve will be normally open, and will close off if bent. Further bending will not make the valve open again.

EP2693090B1 discloses a manual control part of a suction device with a pinch valve. The valve connects to a pipette tip upstream and a manual control part downstream. The valve is opened by easing the pinch through a lever, so as to allow suction at the pipette tip. This document relates to a vacuum aspiration tool, which can be opened/closed. The advantages of a manual pipette handle are not present i.e., it does not comprise a tip ejector button at handle, it is not possible to control aspiration volume, and it lacks the possibility of reversing suction.

None of the above documents, alone or in combination, discloses the valve mechanism operated by the tip ejector button.

According to the present invention, the device may be connected to a vacuum source, while maintaining the benefits of a manual pipette, such as accurate transfer of liquids, a high degree of tactile control over aspiration or dispensing rate and volume, reversibility of any inadvertent suction, and efficient tip ejection at the press of a tip ejector button. Thus, the device incorporates the functions of a pipette tip attached to a suction tube or a vacuum aspirator, and a manual pipette in a single product providing a device with form factor, ergonomics, operating forces identical to existing air displacement micropipettes.

### SUMMARY

Thus, an object of the present invention is to provide a liquid handling tool in the form of a simple to use air displacement pipette having integrated liquid aspiration via a conduit.

A first aspect relates to an air displacement pipette comprising:
two oppositely positioned ends, a first end, and a second end, which second end comprises an opening for fluid and being configured to fit with a disposable tip;
a housing;
a pipetting activator;
a tip ejector activator connected to a tip ejector;
a shaft comprising an air displacing chamber; and
an air displacing body configured to move in said air displacing chamber;
wherein said air displacing body has a forward position, in which it displaces air from said air displacing chamber, and a retracted position,
wherein said air displacement pipette further comprises:
   a suction conduit adapted for being fluidly connected to a suction unit; and
   a valve adapted for controlling the fluid flow through said suction conduit;
wherein said suction conduit is either:
a) fluidly connected to said second end via a through-going opening entering the shaft; or
b) fluidly connected to said second end via an adaptor configured for being releasably/detachably mounted to said second end, said adaptor further configured to fit with a disposable tip.

In one or more embodiments, the air displacing body comprises a through-going opening in fluid connection to said suction conduit.

In one or more embodiments, the valve is either positioned inside said housing or positioned outside said housing.

In one or more embodiments, the suction conduit is fluidly connected to said air displacement chamber.

In one or more embodiments, the valve comprises or is constituted of a flexible tubing and that said valve is closed by kinking of said flexible tubing.

In one or more embodiments, the suction conduit is fixed relative to the housing at or near the first end of the housing, and a tube section constitutes a flexible part and fluid connection between the fixed position of the suction tube and the air displacing body, e.g., the flexibility of the flexible part is obtained by shaping the tube section as a coil.

In one or more embodiments, the tip ejector activator, or tip ejector comprises a valve depressor, which, upon activation of said tip ejector activator, affects said valve.

In one or more embodiments, the body is grasped with a pencil grip and said tip ejector is activated with the index or middle finger by direct impact or through a lever mechanism.

In one or more embodiments, both said pipetting activator, and said tip ejector activator are positioned at said first end, thereby allowing for thumb activation.

A second aspect relates to a method for operating an air displacement pipette according to the present invention and comprising two operation modes, a pipetting mode and an aspiration mode;
in said pipetting mode, the valve is closed, and the following steps are performed:
1) activating the pipetting activator displacing a set amount of air from the air displacing chamber;
2) releasing or re-activating the pipetting activator to draw an amount of liquid corresponding to the set amount of air into the disposable tip; and
3) emptying the set amount of liquid from the disposable tip,
in said aspiration mode, the valve is open, and gas and/or liquid is aspirated from the disposable tip to the suction conduit.

In one or more embodiments, the valve is closed and opened by activating the tip ejector activator.

In one or more embodiments, the valve opening correlates with displacement of the tip ejector activator allowing the user to control the suction force.

In one or more embodiments, the liquid to be removed from a container by suction is first drawn into the disposable tip from the container, optionally then the content in the disposable tip or in the container is checked for content, and then the liquid held in the disposable tip is aspirated from the disposable tip to suction conduit.

In one or more embodiments, the suction unit may be replaced by a pressure unit to provide blowing of fluids, i.e., gases or liquids, from the first end to the second end. This configuration allows a user to wash and/or blow dry equipment.

Universal pipette tips from a wide range of manufacturers are all able to form an airtight seal with the tip holder of most pipette models of the corresponding capacity. The connection is very reliable because of the slight 4-5 degrees Conical taper of the tip holder and pipette tip which makes for a good press fit. However, model variations of the shape of the pipette tip will cause the clearance of the upper edge of the pipette tip and the lower edge of the tip ejector to vary as well.

It is important for proper operation of the tube valve and aspiration function that valve can transition from closed to open before tip ejection takes place.

To ensure this, an advantageous embodiment features a tip ejector with adjustable clearance to the upper edge of the pipette. In this embodiment, the tip ejector can be fixed along the rod of the ejector button. The user will set this distance according to the preferred tip brand.

Another advantageous embodiment, a tactile bump, which marks an important transition of the valve, can be felt through the ejector button independent of the engagement of the tip ejector with the pipette tip. In this embodiment, clearance between tip ejector and pipette tip should exceed the transition travel from valve-closed to valve-open.

In another advantageous embodiment, the tip ejector is not rigidly coupled to the valve depressor and is engaged after a set travel distance of the valve depressor.

Variable volume micropipettes are sold in a variety of sizes spanning from 1-10 μL to 1000-10.000 μL. For the pipetting aspirator, it is likewise beneficial to be able pipette and then aspirate more than 200-300 μL of liquid. To that end, a highly advantageous embodiment of the invention comprises a hollow piston with more than 300 UL air displacement volume, preferably more than 1000 μL.

For pipetting, a relatively large pipette tip can take on a variety of shapes, provided that the tip opening is comparably small. Consequently, e.g., P1000 tips can have relatively large tapers and expand to a diameter of approximately 9 mm.

For continuous aspiration of aqueous media, however, it is important that circular tip and shaft diameters are small, preferably below 6 mm, 5 mm, or 4 mm. This is because in most stages of aspiration, liquid is transferred upwards ballistically as rushing air propels liquid droplets downstream. A small diameter bore enables a relatively high air velocity and shear stress on droplets for a comparably low air flow rate. For larger bores or stepped bores, aspirate may stagnate between the tip and open valve to run down again once the valve closes. This is particularly apparent when aspirating liquids with containing surfactants, or tensides.

A typical P1000 micropipette uses a piston diameter of approximately 9 mm to displace 1000 μL while traveling 16 mm. Displacing 1000 μL with a 4 mm piston will require an un-ergonomically favourable travel distance of 64 mm of the piston button.

Consequently, in a highly advantageous embodiment of the invention, the relatively small diameter piston tube protrudes from a relatively larger diameter air displacing body. The relatively large diameter air displacement body translates inside a correspondingly sized air displacement chamber. In this embodiment, the piston tube does not need to seal against the inside of the tip holder. The air in the air displacement chamber communicates with tip holder bore either through holes or channels in the relatively smaller diameter piston tube and/or through a space bypassing the relatively smaller diameter piston tube. In this embodiment, the air displacement rate is constant throughout the length of pipetting stroke and the blowout stroke.

In an advantageous embodiment of the invention there is a constriction around the channels on the piston tube to use the Venturi effect to prevent aspirate from escape out of the channels during suction.

In another advantageous embodiment, there is a seal against the small diameter piston tube in addition to the seal against the large diameter air displacement body. In such embodiment, the air displacement chamber communicates the pipette tip only through channels in the piston tube.

In a highly advantageous embodiments, the tips used have internal diameters less than 8 mm, 7 mm, or preferably less than 6 mm.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE DRAWINGS

FIG. 1 shows a first embodiment of an air displacing pipette according to the invention seen from a side view.

FIG. 2 shows the same first embodiment of an air displacing pipette as FIG. 1 seen in a see-through-view.

FIG. 3 shows a first embodiment of a valve, which may be used according to the invention, wherein the valve shown in the figure is in a closed state.

FIG. 4A and FIG. 4B show a tube guide which may be used in connection with the first embodiment of the valve shown in FIG. 3.

FIG. 5 shows an enlargement of an embodiment of an air displacement body mounted in an air displacement chamber in a most forward position.

FIG. 6 shows a second embodiment of an air displacing pipette according to the invention where the suction function is provided as an add-on.

FIG. 7 shows a general embodiment, where a volume control bushing is rotationally constrained by a surrounding tube guide.

### DETAILED DESCRIPTION

### Definitions

Prior to discussing the present invention in further details, the following terms and conventions will first be defined:

In general—when these words are used in the specification it is to emphasize that a specified feature may be used together with all embodiments of the invention.

It should be noted that embodiments and features described in the context of one of the aspects of the present invention also apply to the other aspects of the invention.

The invention will now be described in further details in the following non-limiting examples.

The invention relates to an air displacement pipette, which may be used for pipetting in a similar way as a traditional air displacement pipette. Such traditional air displacement pipettes comprise two oppositely positioned ends, a first end 1 and a second end 2, where the second end 2 comprises an opening 3 for fluid. The second end 2 is configured to fit with a disposable tip 4, the disposable tip 4 is chosen relative to the amount and type of liquid, which is to be pipetted with the air displacement pipette.

Further, an air displacement pipette in general comprises:
a housing 5, which outer surface may provide a handle part for the user;
a pipetting activator 6, which is activated during pipetting;
a tip ejector activator 7 connected to a tip ejector 8 and a third spring, an ejector spring 20, which pushes the tip ejector activator back to start position during use, which tip ejector activator 7 is activated when the user wants to release a disposable, used tip 4 from the air displacement pipette;
a shaft 9 comprising an air displacing chamber 10; and
an air displacing body 11, which is configured to move in and out of the air displacing chamber 10 during pipetting to displace air during emptying of the disposable tip 4 moving forward into the air displacing chamber 10, and to aspirate liquid into the disposable tip 4 during filling of the disposable tip 4 when moving backward out of the air displacing chamber 10.

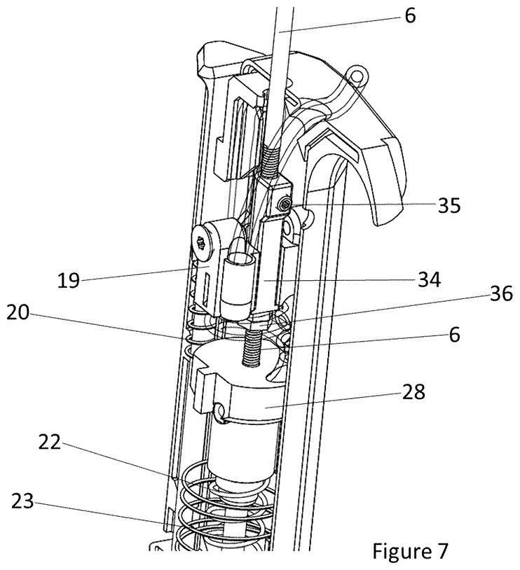

According to the functionality of the air displacing body 11, the air displacing body has a retracted position outside or within the air displacing chamber 10. Furthermore, the air displacing body 11 has a first forward position relative to the retracted position, in which the air displacing body 11 is positioned inside the air displacing chamber 10 and hereby displacing air from the air displacing chamber 10. The volume of air displaced from the retracted position to the forwarded position corresponds to the volume of fluid, which is to be drawn into the disposable tip 4. The air displacing body 11 normally also has a second forward position, where all liquid contained in the disposable tip 4 is pushed out, a so-called blow-out position. This position is farther into the air displacing chamber 10. The blow-out position may, in some embodiments, be reached by counteracting the force of a second spring, the blow out spring 22 (FIG. 7).

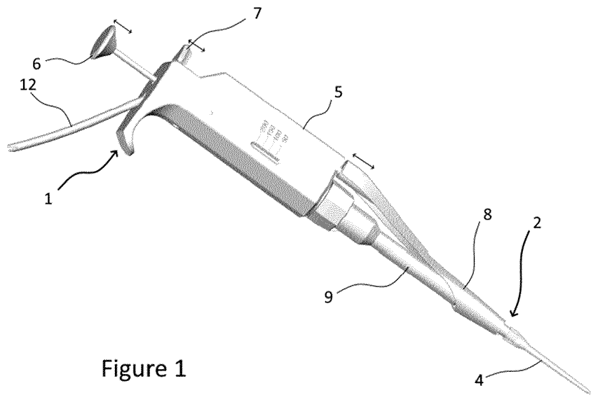

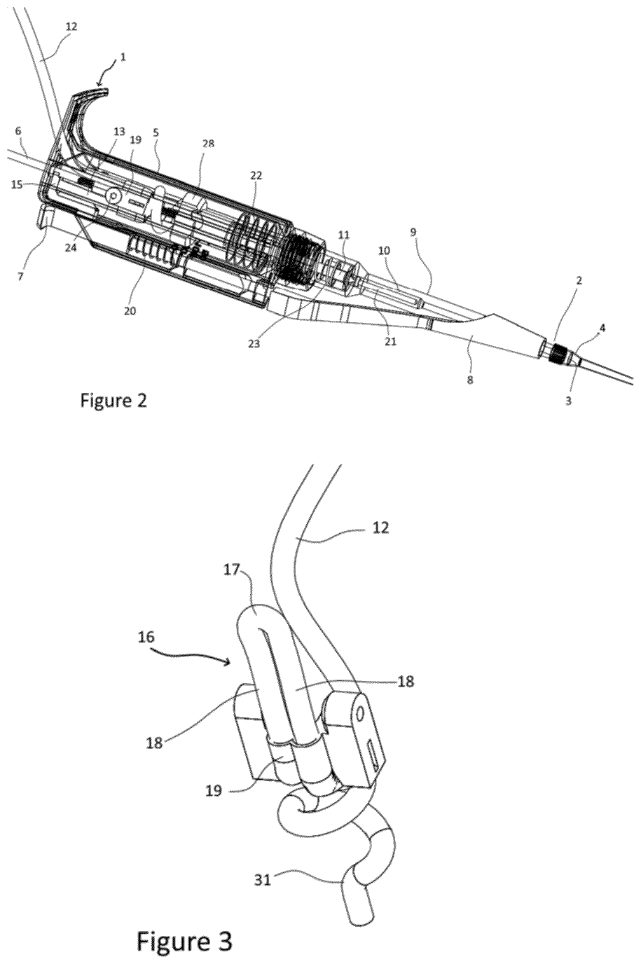

FIG. 1 and FIG. 2 show a first embodiment of an air displacing pipette according to the invention. The embodiment comprises the above listed features of the known pipettes, and the below listed features, which are only present in air displacement pipettes according to the invention. FIG. 2 shows a see-through view of the embodiment, disclosing units constituting the embodiment of an air displacing pipette and how these units may be related to each other.

An air displacement pipette according to the invention comprises:
a suction conduit 12 configured to be fluidly connected to a aspirator unit (not shown in the figures), such as a vacuum pump (over an aspirator bottle), at one end, and at a second end the suction conduit 12 is fluidly connected to the second end 2 of the air displacement pipette, either via a through-going channel entering the shaft 9 as shown in the first embodiment, where “entering” means that the through-going channel opens into the shaft and that liquid may be removed from the shaft through the opening, or by a detachable adaptor e.g., releasably attached and positioned between the shaft 9 and the disposable tip 4, which adaptor may be attached to the shaft 9 both during pipetting and suction; and
a valve 13 configured to control the fluid flow through the suction conduit 12, which valve 13 at least has two operation states namely fully open and fully closed, but according to a preferred embodiment, the opening of the valve 13 may be controlled by the user during operation and the valve 13 may have a plurality of operation states and open and close gradually. In general, when the valve 13 is not influenced by the user, it will be closed, i.e., no suction takes place.

According to an embodiment, the air displacing body 11 is hollow i.e., the air displacing body 11 comprises a through-going opening 14 in fluid connection to said suction conduit 12, which through-going opening 14 opens into the shaft 9.

In general, an air displacing pipette according to the invention may comprise means configured to support or improve suction of liquids with low viscosity or low surface tension, such as surfactant solutions, soaps etc. Limited droplet cohesion may prevent efficient movement of liquid upwards through large bore conduits.

Consequently, liquid may stagnate in the shaft 9 and in the air displacement chamber 10 while suction is applied and flow back into the disposable tip 4.

The means configured to support or improve suction of liquids with low viscosity or low surface tension may comprise:
the inner opening or bore of the shaft 9 comprises a stepped bore diameter, i.e., the diameter of the inner opening of the shaft 9 closest to the second end 2 is smallest, e.g., between 1-2 mm, whereas the diameter of the inner opening of the shaft 9 increases, continually or stepwise, to the largest diameter at the inlet to the air displacement chamber 10, where the diameter may be around 4 mm for a P200 pipette.

In highly advantageous embodiments, a tube with open ends is inserted into the relatively larger hollow displacing body. The displacing body has one or more openings (fluid connections) into the volume of the air displacement chamber 10. The tube may comprise multiple openings distributed along its length. The tube may be fixed and aligned with the hollow displacing body with a ferrule. Said ferrule may comprise peripheral channels to allow aspirated fluid to bypass the hollow tube to enter the ingoing tube section.

In highly advantageous embodiments, a rod is inserted into the relatively larger hollow displacing body. The rod increases available surface area and decreases the free cross-section in the shaft and inside the hollow displacing body. The rod is aligned and fixed using said channelled ferrule.

The means configured to support or improve suction of liquids with low viscosity or low surface tension may also comprise a check valve (not shown in the figures), such as a ball shaped check valve positioned inside the inner opening 14 of the air displacing body 11, normally at the end of the air displacing body 11 being closest to the second end 2. The presence of such a check valve will prevent back flow of liquid when the liquid has entered the air displacing body 11.

The means configured to support or improve suction of liquids with low viscosity or low surface tension may also comprise a capillary tube 21 (embodiment shown in figures) mounted inside the air displacing body 11 and/or extending into the air displacing chamber 10 from the air displacing body 11, i.e., the capillary tube 21 provides a fixed prolongation of the air displacing body 11, which may extend into the part of the shaft below the air displacement chamber 10 during filling and blow out of the air displacement chamber 10.

The valve 13 may be positioned inside said housing 5 or outside said housing 5. If it is positioned outside the housing 5, the valve 13 may be opened and closed by any mechanism attached to or being part of the suction conduit 12. If the valve is positioned inside the housing 5, the mechanism controlling the opening of the valve 13 may reach outside the housing 5. According to one embodiment, the tip ejector activator 7 may act as valve activator and control the degree of opening of the valve 13, that the tip ejector activator 7 acts as valve activator means that a user by impacting the tip ejector activator 7 may open and close the valve 13. The advantage of this embodiment is that a user may operate both suction and ejection of used pipettes with the thumb of the dominant hand. If the valve activator is e.g., positioned on the suction conduit 12, the user may have to operate the valve activator with the digits of the other hand.

The valve 13 may comprise or be constituted of a tube part being buckled upon itself in a kink. An advantage of this type of valve is that it is small and flexible enough to be positioned inside the housing 5. Another advantage of this valve type is that it comprises no joints or moving parts in the fluid line to mitigate failure risk.

FIG. 3 shows an embodiment of a valve 13 comprising a tube part 16 made of a flexible material. The valve 13 comprises three or more tube sections: an outgoing section connected to or being part of the suction conduit 12, a first kinking or closing section 17, which section is bent and therefore closed in a relaxed state (“relaxed state” is a state where the valve is not engaged/influenced by the user), and an ingoing section connected to second end 2 or the shaft, from which liquid is drawn into the ingoing section. The tube sections may be separate sections connected to and directed by a channelled valve body by means of tube fittings, or the tube sections may be parts of a larger construct body, such as contiguous sections of a continuous tube. According to an advantageous embodiment, the tube part 16 is inserted into and positioned by a tube guide 19 that may: 1) secure the valve to the housing 5; 2) direct and/or constrain the placement of the different tube sections; and 3) form and constrain the kinking section 17 to be repeatably engaged by a valve depressor 15 and restored. In an alternative embodiment, the tube guide is part of the pipetting assembly, and the suction conduit is extendable inside the housing.

The tube guide 19 is normally made of a rigid material, such as hard plastic, metal or the like, and the tube guide 19 may be rigidly connected to the housing 5, e.g., by screws 24 passing through corresponding openings in the housing 5 and the tube guide 19.

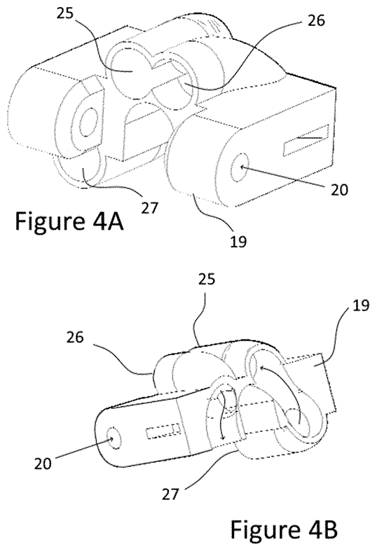

One embodiment of a tube guide 19 is shown in FIG. 4A and FIG. 4B. According to the tube guide shown in FIGS. 3, 4A, and 4B, the suction tube 12 is placed in a first tube guide section 27, which fixes the position of the suction tube 12. The suction tube 12 or the outgoing section of the tube is then bent below the tube guide 19 with an angle large enough to keep the tube open for liquid flow. After the bend, the outgoing tube section extends through the second tube guide section 25, is bent into a kinking bend 17, which will not allow fluid flow in a relaxed state, and after the kinking bend 17, the tube is positioned in a third tube guide section 26, from which guide section the ingoing tube section is directed to and connected to the shaft 9.

According to an embodiment of the invention, the ingoing section is fluidly connected to the air displacing body 11. That the ingoing section is “fluidly connected” means that gas and liquid may flow through one unit and into the other. According to such an embodiment the ingoing section may comprise a flexible means i.e., the ingoing section is able to adapt in length to the longitudinal displacement of the air displacing body 11. Such flexible means may comprise that the ingoing section has a coil shape as illustrated in FIG. 4B, or a functionally similar form allowing for point-to-point extension and shortening of the ingoing section in a longitudinal direction without substantially changing the inner cross section of the ingoing section.

The tube guide 19 bends the ingoing and outgoing tube sections while preventing the tube sections from closing off the lumen by kinking. This embodiment allows for tighter curvatures than what may be expected from the tube's bend radius and thus provides a more compact valve.

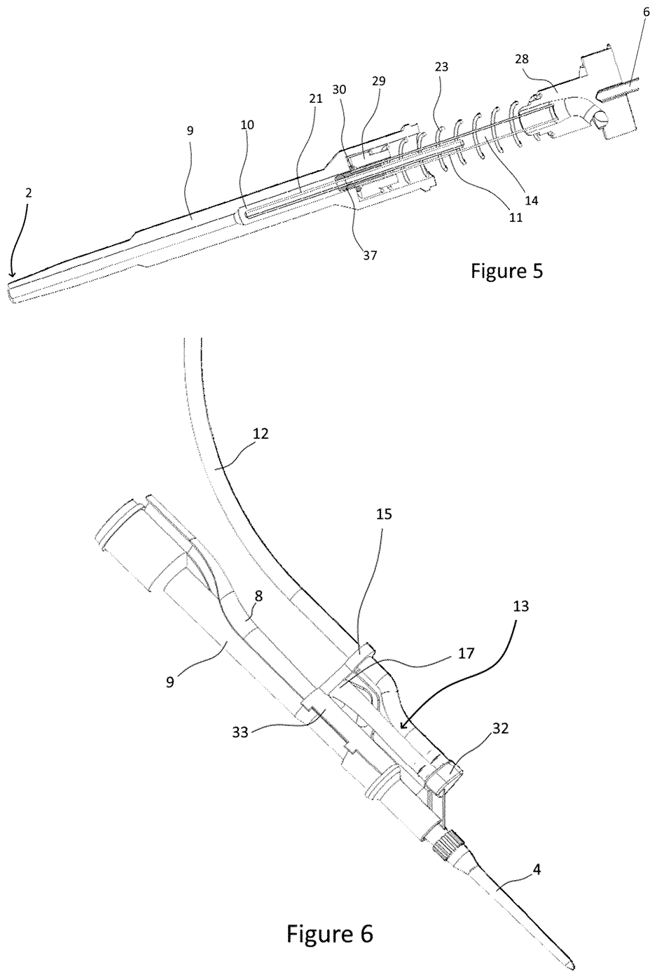

The lower surface of the tube guide 19 may serve as an upper travel limiter to a volume control bushing 34 on a threaded rod part of the pipetting activator 6 (See FIG. 7). The volume control bushing 34 is rotationally constrained by the surrounding tube guide 19 and rests against the underside of the tube guide 19 under spring pressure from the first spring 23. Rotating the pipetting activator shaft 6, in one or the other direction, thus moves the resting position of the pipetting assembly comprising the pipetting activator shaft 6, volume control bushing 34, and displacing body holder 28 either forward or backwards relative to the air displacing chamber 10, i.e., changing the retracted position of the air displacing body and the set volume of the pipette. The set volume is visualized to the user with an indicator. The threaded part of the shaft 6 does not screw into the air displacing body holder 28 but rotates freely in a central recess (see FIG. 5). In an advantageous embodiment, the pipetting assembly comprises means, such as a socket screw 35, to lock rotation and inadvertent maladjustment of the sample volume is thus prevented. In an especially advantageous embodiment, the means for locking are accessible from the outside of the housing.

In an advantageous embodiment, the shaft 6 is prevented from disengaging the volume control bushing 34 by a locked nut 36 placed on the shaft 6 between the volume control bushing 34 and the air displacing body holder 28.

In other embodiments, the valve 13 may be of a more conventional type. However, conventional valves may include increased complexity/more seals, increased weight and size, increased cost, increased need for lubrication, increased levels of friction/increased operating forces, increased stroke length, decreased chemical resistance, decreased thermal resistance.

The shown embodiment of the valve 13 may be operated by pressing on the tube part 16 at the position of the kinking or closing section 17. When the kink 17 is pushed down toward the tube guide 19, the kink 17 unbuckles i.e., the tube part straightens, and opens for the lumen of the kinking tube part 16 allowing liquid or gas to flow through the suction conduit 12. If the tube part 16 is subjected to farther press, the valve 13 may once again be closed off as to two new kinks 18 may be formed at new positions of the tube part 16. When the pressure is released, the elasticity of the tube part may provide the valve 13 to return to its original shape, if the elasticity of the tube part 16 alone cannot make the valve 13 return to its original shape, support units controlled by the user may force the valve 13 to return to its original shape.

A valve depressor 15 may be used by the operator or user to activate the valve 13, i.e., force it into an open or second closed position. The tip ejector activator 7, which is normally a button operated by a user, may be connected to the valve depressor 15 e.g., by a rigid connection.

According to an advantageous embodiment, the valve depressor 15 may be linked to the tip ejector activator 7 through rack and pinion, or 1, 2, 3, 4 bar linkages to provide leverage. The valve depressor 15 may be linked to a valve restorer that is placed opposite the tube part 16 constituting the valve 13. The valve restorer may provide means to push the valve 13 away from the two-kink state and back into the first one-kink state upon release of the tip ejector activator 7.

During operation, the user presses down on the tip ejector activator 7 to instigate aspiration. During this pressure, the third spring i.e., the ejector spring 20 is biased. Over a certain range, the displacement of the tip ejector activator 7 may correlate with the flow rate through the valve 13. Near the end of the movement of the tip ejector activator 7, tactile stiction of an attached disposable tip 4 may be felt through an incompressible assembly comprising the tip ejector activator 7 and the tip ejector 8. Thereby, inadvertent ejection or loosening of the disposable tip 4 may be reflexively avoided by the user. In an advantageous embodiment, a tactile mechanism, such as a mechanical bump, enhances the tactility of the valve transition independent of tip stiction.

The transition between the closed-open-closed states of the valve 13 may occur through a linear stroke of 6 mm (ranging from 4-12 mm), which is the typical free stroke distance of tip ejector mechanisms on common air displacement pipettes.

The embodiment of the valve 13 shown in Fig . . . 3 may need an initial force for opening of approximately 1 N, to start unbuckling of the tube part 16. This may be followed by a flat force curve of about 0.5 N until the end of a stroke where the tube part 16 re-buckles with two kinks 18. The initial buckling force gives the users a tactile cue that the valve is about to open, however, the forces exerted by the valve are overshadowed by the spring forces from the ejector spring, normally encountered in tip ejectors of common pipettes and stiction of the attached tip.

The valve's closed-open-closed cycle is highly advantageous for achieving familiar tip ejection tactility. If the closed state at the end of an ejection stroke is omitted, tip ejection must be done against an open and potentially strong vacuum source and requiring a longer ejection stroke, which is detrimental to user comfort.

When both the pipetting activator 6 and said tip ejector activator 7 are positioned at the first end of an air displacement pipette, a user may activate both activators by the thumb of the hand holding the pipette.

The air displacement body 11 is made of a rigid material and extending longitudinally inside the shaft 9, which comprises the air displacement chamber 10 and/or the housing 5. In general, the air displacement chamber 10 may be positioned either in the shaft 9 or in the housing 5 depending on where the exact limit between the two parts is established in a given embodiment. According to some embodiments, the shaft 9 may be a part of the housing 5. The air displacing body 11 may be shaped as a cylinder, or at least comprise a cylindrical part or segment, having one or more through-going openings 14.

The volume to be drawn into the disposable tip 4 of the air displacement pipette during a pipette operation can be varied. In general, an air displacement pipette according to the invention comprises a volume control unit or assembly configured to vary the amount of liquid aspirated into the disposable tip 4 by varying or controlling the forward displacement of the air displacing body 11.

According to the shown embodiment, the air displacing body 11 is fixed to an air displacing body holder 28 at a first end, and at the opposite end, the air displacing body 11 is guided by an annular seal 30 positioned by a bushing 29. The air displacing body holder 28 is movably mounted inside the housing 5 and may be moved between two or more positions by the pipetting activator 6 and is rotationally constrained by guide rails and/or guide slots (not shown) formed on the inner faces of the housing 5. According to the embodiment shown in FIGS. 1, 2, and 5, a user controls the volume by rotating the pipetting activator 6. A specific embodiment of such as mechanism is described above and includes said volume control bushing 34.

A first spring 23 is positioned between the movable air displacing body holder 28 and the stationary air displacing body guide 29, where the words “movable” and “stationary” define how the units move relative to the housing 5 and the shaft 9. When a user pushes the pipette activator 6 towards the second end 2, the air displacing body holder 28 together with the air displacing body 11 are moved forward into the air displacing chamber 10, while the shown helical spring is biased and the air displacing body 11 is guided into the air displacing chamber 10 by the air displacing body guide 29.

The air displacing body guide 29 is stationary relative to the shaft 9 and housing 5, because the first spring 23 forces it towards the shoulders of the shaft 9.

FIG. 6 discloses a second embodiment of an air displacement pipette according to the invention. As the first embodiment, the second embodiment also comprises similar elements as traditionally known air displacement pipettes:
a housing which outer surface may provide a handle part for the user,
a pipetting activator being activated during pipetting,
a tip ejector activator connected to a tip ejector 8 and a spring, an ejector spring,
a shaft 9 comprising an air displacing chamber, and
an air displacing body being configured to move in and out of the air displacing chamber.

Not all these commonly known features are shown in the figures illustrating the second embodiment. However, the commonly known features and the functionality of these features are generally known to a person skilled in the art.

The second embodiment comprises features which may be added on to an existing traditional air displacement pipette to obtain an air displacement pipette able to remove liquid by manually controlled suction.

An air displacement pipette according to the second embodiment comprises a suction conduit 12 and a valve 13 controlling the fluid flow through the suction conduit 12. The valve 13 will normally be positioned outside said housing 5 and the valve 13 may be opened and closed by any mechanism attached to or being part of the suction conduit 12.

According to an embodiment, the tip ejector activator may act as valve activator and control the degree of opening of the valve 13, that the tip ejector activator 7 acts as valve activator means that a user by impacting the tip ejector activator 7 may open and close the valve 13. The tip ejector activator may be connected to the valve via an ejector connector 33 fixed to the tip ejector 8 during operation, and like in the first embodiment, a valve depressor 15 may be part of, or be connected to, the ejector connector 33 in such a way that the valve depressor moves together with the tip ejector 8 in such a way that the tip ejector activator may be used to control both valve opening and tip ejection.

The valve 13 may comprise or be constituted of a tube part being buckled upon itself in a kink. FIG. 6 shows an embodiment of a valve 13 comprising a tube part made of a flexible material. The embodiment of the valve 13 comprises two tube sections: an outgoing section being part of the suction conduit 12 and a first kinking or closing section 17, which section is bend and therefore closed in a relaxed state.

The fluid connection to the second end 2 of the shaft 9 is constituted by a rigid fluid connection being part of a valve connector 32.

The valve connector 32 comprises an inlet connector fixed to the suction tube during operation, a first valve connector fixed to a first end of a tube valve during operation, and a second valve connector fixed to a second end of the tube valve during operation. The valve connector 32 also comprises the fluid connection between the second valve connector and a shaft connector which shaft connector comprises fastening means which fixes the valve connector 32 to the shaft 9 during operation.

The valve 13 may be of a more conventional type.

The shown valve 13 may be operated by pressing perpendicularly toward the kinking position 17 and when the kink 17 is pushed down toward the valve connector, the kink 17 unbuckles i.e., the kinking part straightens, and opens for the lumen of the tube part allowing liquid or gas to flow through the suction conduit 12. If the tube part is subjected to further press, the valve 13 may once again be closed off as to two new kinks may be formed at new positions of the tube part. When the pressure is released, the elasticity of the tube part may provide the valve 13 to return to its original shape, if the elasticity of the tube part alone cannot make the valve 13 return to its original shape, support units controlled by the user may force the valve 13 to return to its original shape.

The invention also relates to a method for operating an air displacement pipette according to the invention. In general, a pipette according to the invention comprises two operation modes, a pipetting mode and an aspiration mode.

In pipetting mode, the valve 13 is closed, and the following steps are performed:
1) activating the pipetting activator 6 displacing a set amount of air from the air displacing chamber 10;
2) releasing or re-activating to pipetting activator 6 to draw an amount of liquid corresponding to the set amount of air into the disposable tip 4; and
3) emptying the set amount of liquid from the disposable tip 4.

In aspiration mode, the valve 13 is open, and gas and/or liquid is aspirated from the disposable tip 4 to the suction conduit 12, and guided to a waste container, another collection container or similar.

Liquid to be removed from a container by aspiration may first be drawn into the disposable tip 4 from the liquid-holding container, then it will be possible to assess the content in the disposable tip 4 or the content of the liquid-holding container to determine if undesired matter has been inadvertently drawn into the disposable tip 4.

If only desired liquid is held in the disposable tip 4, aspiration operation may be continued, whereas if undesired matter has been drawn into the disposable tip 4, it may be chosen to release the liquid from the disposable tip 4 back into the liquid-holding container.

The invention may also relate to a method to operate an air displacement pipette according to the invention with a reversed pressure gradient from the second end to the first end. In such a pressure mode the suction unit is replaced by a pressure unit to provide air, clean dry nitrogen, or liquid flowing from the first end to the second end to exit through the disposable tip. The flow is controlled by means of the said valve. This function is useful within the field of e.g., experimental physics or materials science, e.g., for cleaning coated optic components, such as lenses or beamsplitters, which are rinsed with a volume of fresh solvent and then quickly blown with clean dry air to remove dirt or debris and to avoid leaving drying marks.

| Ref. no. | Name |
|---|---|
| 1 | First end of air displacement pipette |
| 2 | Second end |
| 3 | Opening of second end |
| 4 | Disposable tip |
| 5 | Housing/body shell |
| 6 | Pipetting activator |
| 7 | Tip ejector activator/valve activator |
| 8 | Tip ejector |
| 9 | Shaft |
| 10 | Air displacing chamber |
| 11 | Air displacing body/piston |
| 12 | Suction conduit |
| 13 | Valve controlling flow through suction conduit |
| 14 | Through-going opening in air displacing body |
| 15 | Valve depressor |
| 16 | Flexible tube part of valve |
| 17 | Position of closing kink |
| 18 | Positions of two closing kinks |
| 19 | Tube guide |
| 20 | Third spring/ejector spring |
| 21 | Capillary tube |
| 22 | Second spring/blow out spring |
| 23 | First spring/piston spring |
| 24 | Screws fastening tube guide to housing |
| 25 | Second tube guide section |
| 26 | Third tube guide section |
| 27 | First tube guide section |
| 28 | Air displacing body holder |
| 29 | Air displacing body guide |
| 30 | Sealing means/O-ring |
| 31 | Ingoing section of tube part 16 |
| 32 | Valve connector |
| 33 | Ejector connector |
| 34 | Volume control bushing |
| 35 | Socket screw |
| 36 | Nut |
| 37 | Channelled ferrule |

1. An air displacement pipette comprising:
two oppositely positioned ends, a first end (1) and a second end (2), which second end (2) comprises an opening (3) for fluid and configured to fit with disposable tips;
a housing (5);
a pipetting activator (6);
a tip ejector activator (7) connected to a tip ejector (8);
a shaft (9) comprising an air displacing chamber (10); and
an air displacing body (11) configured to move in said air displacing chamber (10);
wherein said air displacing body (11) has a forward position, in which it displaces air from said air displacing chamber (10), and a retracted position,
wherein said air displacement pipette further comprises:
a suction conduit (12) configured for fluid connection to a suction unit; and
a valve (13) configured to control fluid flow through said suction conduit (12);
wherein said suction conduit (12) is either:
a) fluidly connected to said second end (2) via a through-going opening entering the shaft (9); or
b) fluidly connected to said second end (2) via an adaptor configured for releasable mounting to the second end (2), said adaptor further configured to fit with a disposable tip (4).

2. The air displacement pipette according to claim 1, wherein said air displacing body (11) comprises a through-going opening (14) in fluid connection to said suction conduit (12).

3. The air displacement pipette according to claim 1, wherein said valve (13) is either positioned inside said housing (5) or positioned outside said housing (5).

4. The air displacement pipette according to claim 1, wherein said suction conduit (12) is fluidly connected to said air displacement chamber (10).

5. The air displacement pipette according to claim 1, wherein said valve (13) comprises or is constituted of a flexible tubing (16) and that said valve (13) is closed by kinking of said flexible tubing (16).

6. The air displacement pipette according to claim 1, wherein the suction conduit (12) is fixed in position relative to the housing (5) at the first end (1) of the housing (5), and a tube section constitutes a flexible part and fluid connection between the fixed position of the suction conduit (12) and the air displacing body (11), wherein flexibility of the flexible part is obtained by shaping the tube section as a coil.

7. The air displacement pipette according to claim 1, wherein said tip ejector activator (7) or said tip ejector (8) comprises a valve depressor (15), which upon activation of said tip ejector activator (7) impacts said valve (13).

8. The air displacement pipette according to claim 1, wherein both said pipetting activator (6) and said tip ejector activator (7) are positioned at said first end (1), thereby allowing for thumb activation.

9. A method for operating an air displacement pipette according to claim 1 comprising two operation modes, a pipetting mode and an aspiration mode;
in said pipetting mode, the valve (13) is closed, and the following steps are performed:
1) activating the pipetting activator (6) displacing a set amount of air from the air displacing chamber (10);
2) releasing or re-activating to pipetting activator (6) to draw an amount of liquid corresponding to the set amount of air into the disposable tip (4); and
3) emptying the set amount of liquid from the disposable tip (4),
in said aspiration mode, the valve (13) is open, and gas or liquid is aspirated from the disposable tip (4) to the suction conduit (12) or both gas and liquid are aspirated from the disposable tip to the suction conduit.

10. The method according to claim 9, wherein the valve (13) is closed and opened by activating the tip ejector activator (7).

11. The method according to claim 9, wherein the valve opening correlates with displacement of the tip ejector activator (7) allowing user control of suction force.

12. The method according to claim 9, wherein liquid to be removed from a container by suction is first drawn into the disposable tip (4) from the container, optionally then the content in the disposable tip (4) or in the container is checked for content, and then the liquid held in the disposable tip (4) is aspirated from the disposable tip to the suction conduit (12).
